(19) United States
(12) Patent Application Publication
(10) Pub. No.: US 2006/0011863 A1
(43) Pub. Date: Jan. 19, 2006

(54) Electron beam method and apparatus for improved melt point temperatures and optical clarity of halogenated optical materials

(75) Inventors: William R. Livesay, San Diego, CA (US); Scott M. Zimmerman, Baskin Ridge, NJ (US)

Correspondence Address: William Propp, Esq.;e-Beam & Light, Inc., Suite A, 6150 Yarrow Drive, Carlsbad, CA, 92011, US

(73) Assignee: e-Beam & Light, Inc.

(21) Appl. No.: 11/230,389

(22) Filed: Sep. 20, 2005

Related U.S. Application Data
(63) Continuation-in-part of application No. 10/183,784, filed on Jun. 27, 2002, now abandoned.
(60) Provisional application No. 60/302,152, filed on Jun. 28, 2001.

(51) Int. Cl. G21G 5/00

(52) U.S. Cl. 250/492.1

(57) ABSTRACT

A controlled electron beam and heat will increase the melt point temperature and improve the optical clarity of a halogenated optical material. The electron beam and heat irradiation will occur in a chamber under near vacuum conditions. The electron beam imparts sufficient energy to the chemical bonds within the halogenated optical material to create scissions, which leads to the formation of additional networking bonds as these bonds recombine within the material. The change in melt point temperatures and optical clarity, is due to the process of scission and reformation within the halogenated optical material.

THIS APPLICATION IS A CONTINUATION-IN-PART OF U.S. patent application Ser. No. 10/183,784 TITLED “METHOD AND APPARATUS FOR FORMING OPTICAL MATERIALS AND DEVICES” FILED ON Jun. 27, 2002, WHICH CLAIMS THE BENEFIT OF U.S. PROVISIONAL APPLICATION No. 60/302,152 TITLED “NOVEL OPTICAL MATERIALS FORMED USING ELECTRON BEAM IRRADIATION AND METHODS FOR FORMING OPTICAL DEVICES” FILED ON Jun. 28, 2001.

### BACKGROUND OF THE INVENTION

1. Field of the Invention

The present invention relates generally to the fabrication of optical materials by electron beam radiation and more specifically to an apparatus and method for fabricating optical devices with an increased melt point temperature and improved optical clarity utilizing electron beam radiation.

2. Description of the Prior Art

The relatively low melt point of certain waxes, oils and polymers has restricted their use in high temperature applications. The waxes, oils and polymers are restricted to applications that remain safely below their melt point temperatures.

Similarly, the opaqueness and general lack of optical transparency of certain waxes, oils and polymers has restricted their use in light-transmissive optical applications. The waxes, oils and polymers are restricted to optical applications where their optical clarity is not required.

Halogenated optical materials are chemical compounds or chemical mixtures that contain halogen atoms, such as fluorine (F), chlorine (Cl), bromine (Br), and iodine (I).

Halogenated optical materials, such as Teflon, typically are not radiation curable. They however have superior optical transmission characteristics, especially in the infrared spectrum as used in telecommunications, but typically also exhibit a high degree of crystallinity which leads to a high level of light scatter. This has prompted many manufacturers to develop amorphous versions of the halogenated optical materials, which are extremely expensive and exhibit poor mechanical properties.

It is an object of the present invention to provide an electron beam irradiation method and apparatus to increase the melt point of halogenated optical materials starting with low molecular weight halogenated waxes, oils and polymers.

It is another object of the present invention to provide an electron beam irradiation method and apparatus to improve the optical clarity of halogenated optical materials by decreasing the degree of crystallinity.

### SUMMARY OF THE INVENTION

The starting halogenated optical material is deposited on a substrate. The substrate is then exposed with the electron beam at an energy and dose, while the substrate is heated to the appropriate temperature, to raise the melt point temperature and increase the optical transparency of the optical material on the substrate. The optical material and substrate are preferably loaded into a vacuum chamber with a flood electron source to expose the top side of the substrate and a heating element to apply heat to the back-side of the substrate. The method utilizes a large area electron beam exposure system in a soft vacuum environment. By adjusting the process conditions, such as electron beam total dose and energy, temperature of the selected optical material, and ambient atmosphere (devoid of oxygen), the melt temperature, optical clarity and refractive index of the halogenated optical material can be altered.

The electron beam imparts sufficient energy to the chemical bonds within the optical material to create scissions, which leads to the formation of additional networking bonds as these bonds recombine within the material. The change in melt point temperatures and optical clarity, is due to the process of scission and reformation within the optical material.

The invention provides an apparatus and method for forming optical components and new optical materials utilizing electron beam irradiation. The process comprises selectively irradiating optical materials to increase their melt point temperature and improve their optical clarity. With the inventive process, new optical materials can be created by altering the bond structure within the material such that enhanced optical properties are achieved over the native un-irradiated material.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures so not depart from the spirit and scope of the invention is its broadest form.

### BRIEF DESCRIPTION OF THE DRAWINGS

Other aspects, features, and advantages of the present invention will become more filly apparent from the following detailed description, the appended claim, and the accompanying drawings in which:

FIG. 1 shows a schematic view of a large area electron beam exposure apparatus;

FIG. 2 shows the operation of the electron source;

FIG. 3 shows in FIGS. 3A, 3B, and 3D schematic views of increasing the melt point and the optical clarity of an optical material by electron beam irradiation; and

FIG. 4 shows in FIGS. 3A, 3B, and 3D schematic views of increasing the melt point and the optical clarity of selected areas of an optical material by electron beam irradiation through an aperture mask.

### DETAILED DESCRIPTION OF THE INVENTION

The exposure of selected optical materials to electron beam irradiation can convert the existing material into a new state, which exhibits more desirable optical and mechanical properties not present in the un-irradiated material. The introduction of extra bonds within halogenated optical materials, including oils, waxes and polymers, results in higher melt point temperatures and improved optical clarity. Optical clarity means making the halogenated optical material less hazy, more clear, more optically transparent to light with less light scatter.

The electron beam imparts sufficient energy to the chemical bonds in the optical materials to create scissions, which leads to the formation of additional networking bonds as these reactive entities recombine within the optical material. The change in melt point temperatures and optical clarity, is due to the process of scission and reformation and (to a lesser extent) due to the extraction of low molecular weight components that are volatilized by the e-beam that are removed by the vacuum system. Starting optical materials such as halogenated optical materials, including oils, waxes and polymers, can be converted using this approach. These materials do not outgas significantly in soft vacuum (10-50 millitorr).

Typical polymer materials include halogenated polyalkylenes, preferred fluorinated an/or chlorinated polyalkylens, more preferred chlorofluoropolyalkylens, and most preferred are the fluorinated polyalkylenes among which are included: polytetrafluoroethane(ethylene), polytrifluoroethylene, polyvinylidene fluoride, polyvinylfluoride, copolymers of fluorinated ethylene or fluorinated vinyl groups with non-fluorinated ethylenesor vinyl groups, and copolymers of fluorinated ethylenes and vinyls with straight or substituted cyclic fluoroethers containing one or more oxygens in the ring. Also included in the most preferred polymers are poly(fluorinated ethers) in which each linear monomer may contain from one to four carbon atoms between the ether oxygens and these carbons may be perfluorinated, monofluorinated, or not fluorinated.

Also included in the most preferred polymers are copolymers of wholly fluorinated alkylenes with fluorinated ethers, partly fluorinated alkylenes with wholly fluorinated ethers, wholly fluorinated alkylenes with partly fluorinated ethers, partly fluorinated alkylenes with partly fluorinated ethers, non-fluorinated alkylenes with wholly or partly fluorinated ethers, and non-fluorinated ethers with partly or wholly fluorinated alkylenes.

Also included among the most preferred polymers are copolymers of alkylenes and ethers in which one kind of the monomers is wholly or partly substituted with chlorine and the other monomer is substituted with fluorine atoms. In all the above, the chain terminal groups may be similar to those in the chain itself, or different.

Also among the most preferred polymers are included substituted polyacrylates, polymethacrylates, polyitaconates, polymaleates, and polyfumarates, and their copolymers, in which their substituted side chains are linear with 2 to 24 carbon atoms, and their carbon atoms are fully fluorinated except for the first one or two carbons near the carboxyl oxygen atom such as Fluoroacrylate, Fluoromethacrylate and Fluoroitaconate.

Among the more preferred polymers, one includes fluoro-substituted polystyrenes, in which the ring may be substituted by one or more fluorine atoms, or alternatively, the polystyrene backbone is substituted by up to 3 fluorine atoms per monomer. The ring substitution may be on ring carbons No. 4, 3, 2, 5, or 6, preferably on carbons No. 4 or 3. There may be up to 5 fluorine atoms substituting each ring.

Among the more preferred polymers, one includes aromatic polycarbonates, poly(ester-carbonates), polyamids and poly(esteramides), and their copolymers in which the aromatic groups are substituted directly by up to four fluorine atoms per ring one by one on more mono or trifluoromethyl groups.

Among the more preferred polymers, are fluoro-substituted poly(amic acids) and their corresponding polyimides, which are obtained by dehydration and ring closure of the precursor poly(amic acids). The fluorine substitution is effected directly on the aromatic ring. Fluoro-substituted copolymers containing fluoro-substituted imide residues together with amide and/or ester residues are included.

Also among the more preferred polymers are parylenes, fluorinated and non-fluorinated poly(arylene ethers), for example the poly(arylene ether) available under the tradename FLARE™ from AlliedSignal Inc., and the polymeric material obtained from phenyl-ethynylated aromatic monomers and oligomers provided by Dow Chemical Company under the tradename SiLK™, among other materials.

In all the above, the copolymers may be random or block or mixtures thereof.

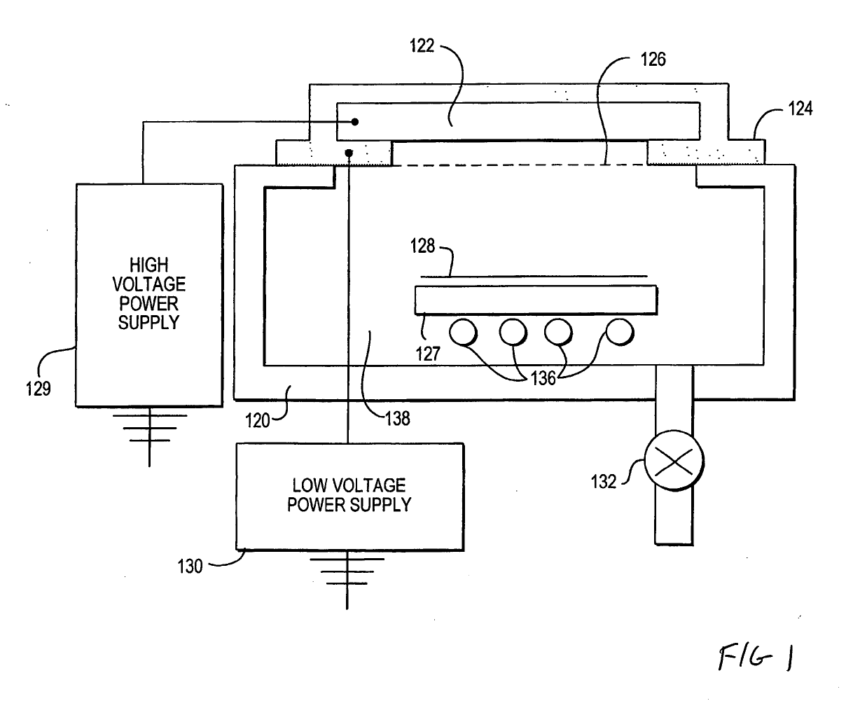

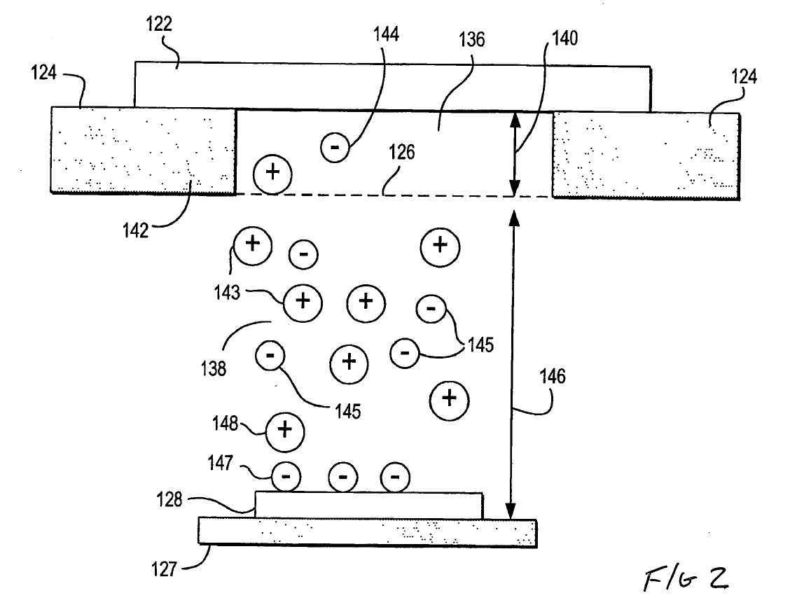

The method of creating new optical materials from these conventional halogenated optical materials, including waxes, oils and polymers, according to the present invention, is depicted in FIGS. 1 and 2. A substrate 127 is placed in a vacuum chamber 120 at a pressure of 15-40 milliTorr and underneath an electron source at a distance from the source sufficient for the electrons to generate ions in their transit between the source and the substrate surface. The electrons can be generated from any type of source that will work within a soft vacuum (15-40 milliTorr) environment. A source particularly well suited for this is described in U.S. Pat. No. 5,003,178, the disclosure of which is hereby incorporated into this specification by reference. This is a large uniform and stable source that can operate in a soft vacuum environment. The cathode 122 emits electrons, which are accelerated by the field between the cathode and anode 126. The potential between these two electrodes is generated by the high voltage supply 129 applied to the cathode 122 and the bias voltage supply 130 applied to the anode 126. The electrons irradiate the starting optical material layer 128 coated on the substrate 127. The starting optical material layer 128 may be any of the oils or waxes previously mentioned. An electron energy is selected to either fully penetrate or partially penetrate the full thickness of starting optical material layer 128. For example, an electron beam energy of 9 keV is used to penetrate a 6000 angstrom thick film. Infrared quartz lamps 136 irradiate the bottom side of the substrate providing heating independent from the electron beam. A variable leak valve or mass flow controller, identified by reference 132, is utilized to leak in a suitable gas to maintain the soft vacuum environment.

Referring to FIG. 2, electrons 145 traversing the distance 146 between the anode 126 and the substrate 127 ionize the gas molecules located in region 138 generating positive ions. These positive ions 143 are then attracted back to the anode 126 where they can be accelerated, as indicated at 142, toward the cathode to generate more electrons. The starting optical material layer 128 on the substrate 127 is an insulator and will begin to charge negatively, as indicated at 147, under electron bombardment. However, the positive ions near the substrate surface will be attracted to this negative charge and will then neutralize it. The IR quartz lamps 136 (FIG. 1) irradiate and heat the starting optical material layer or substrate thereby controlling its temperature. Since the starting optical material layer is in a vacuum environment and thermally isolated, the starting optical material layer can be heated or cooled by radiation. If the lamps are extinguished, the starting optical material layer will radiate away its heat to the surrounding surfaces and gently cool. In one embodiment of the invention, the starting optical material layer is simultaneously heated by the infrared lamps and irradiated by the electron beam throughout the entire process.

In the present method, a solution containing a layer of oil or wax is deposited on substrate 127 by conventional means such as spin-coating or, alternatively, spray-coating or dip-coating to form starting optical material layer 128. Substrate 127 can represent any layer or stack of layers on a multiple-optical layer device. The coated substrate is continuously irradiated with electrons until a sufficient dose has accumulated to attain the desired change in the material and affect certain properties such as melt point and optical clarity. A total dose of between 10 and 100,000 microCoulombs per square centimeter (μC/cm²) may be used. Preferably, a dose of between 100 and 10,000 μC/cm² is used, and most preferably a dose of between about 2,000 and 5,000 μC/cm² is used. The electron beam is delivered at an energy of between 0.1 and 100 keV, preferably at an energy between 0.5 and 20 keV, and most preferably at an energy between 1 and 10 keV. The electron beam current ranges between 0.1 and 100 mA, and more preferably between 0.25 and 30 mA. The entire electron dose may be delivered at a single voltage.

Alternatively, particularly for starting optical material layer thicker than about 0.25 μm, the dose is divided into steps of decreasing voltage, which provides a “uniform dose” process in which the starting optical material layer is irradiated from the bottom up. The higher energy electrons penetrate deeper into the starting optical material layer. In this way, the depth of electron beam penetration is varied during the electron exposure process resulting in a uniform energy distribution throughout the starting optical material layer. The variation allows for volatile components, such as solvent residues, to leave the film without causing any damage such as pinholes or cracks. This also attains uniformity throughout the layer exposed. Alternatively, the electron energy can be varied to achieve a precise dose and index change spatially within the starting optical material layer.

During the electron beam exposure process, the starting halogenated optical material layer is kept at a temperature between 10 degrees Celsius and 1000 degrees Celsius. Preferably, the wafer temperature is between 30 degrees Celsius and 500 degrees Celsius. For some waxes and other low melting point materials low temperatures are utilized (25 degrees to 175 degrees Celsius). The infrared quartz lamps 36 are on continuously until the starting optical material layer temperature reaches the desired process temperature. The lamps are turned off and on at varying duty cycle to control the starting optical material layer temperature.

Typical background process gases in the soft vacuum environment include nitrogen, argon, oxygen, ammonia, forming gas, helium, methane, hydrogen, silane, and mixtures thereof. For many starting halogenated optical materials, a non-oxidizing processing atmosphere is used. In addition to a near vacuum ambient atmosphere devoid of oxygen, the electron beam irradiation of the starting halogenated optical material and the heating of the starting halogenated optical material above the melt point will de-gas oxygen from the starting halogenated optical material. The degassing of oxygen will decrease the crystallinity of the starting halogenated optical material and increase the cross-links and amorphous nature within the resulting irradiated halogenated optical material.

The optimal choice of electron beam dose, energy, current, processing temperature, and process gas depends on the composition of the starting optical material, wax or oil.

The optical starting material may be deposited onto a suitable substrate. Typical substrates include glass, silicon, metal, and polymer films. Substrates can also be porous, textured or embossed. Deposition on substrates may be conducted via conventional spin coating, dip coating, roller coating, spraying, embossing, chemical vapor deposition methods, or meniscus coating methods, which are well known in the art. Spin coating on substrates is most preferred. Multiple layers of different materials are also preferred. Layer thicknesses typically range from 0.01 to 20 microns. 1 to 10 microns is preferred. In another embodiment of the invention, the optical starting material is formed into a supported film similar to pellicles used in semiconductor applications. In this case, films may be formed by casting, spin coating, and dip coating, lifted off the substrate and attached to a frame for handling. In addition, extruded films can be attached to a frame, all of which are well known in the art. Casting, with lift-off and frame attachment is preferred. Single layered films exhibit thicknesses ranging from 1 micron to 10 microns. Multiple layers of different materials are also possible. Once the article has been formed, the exposure equipment needs to be selected.

Exposure of the material can be done with any type of low energy electron source, preferably in the range of 1 to 50 keV. Soft vacuum (15-40 millitorr) is also preferred for removal of volatiles and usage of low keV electrons. In the preferred embodiment of this invention, the optically useful material, either on a substrate or as supported film, is selectively exposed to the electron beam and heated using the IR lamps. Selective heating is also preferred. The IR lamps typically operate from room temperature to 400 degrees Celsius. Most materials exhibit different e-beam irradiation responses depending on the temperature of the material. In addition, post annealing can eliminate charge gradients in electrodes formed during irradiation. Other functions such as transmission loss, polarization sensitivity, and back reflections can all be monitored during exposure and used in a feedback loop to the exposure parameters. In-situ feedback during exposure is an embodiment of this invention. Various gases can be introduced during the irradiation process. It has been shown that these gases can be reacted into the starting optical material layer depending on the material and exposure conditions. Introduction of a reactive or non-reactive gas into the starting optical material layer during exposure is a further embodiment of this invention. Radial exposure conditions, as well as other non-flat configurations, are embodiments of this invention as well as modification of the electron field using external means such as magnetic fields. Once the equipment is selected, the exposure conditions are selected.

Typically the starting optical material layer is exposed to a sequential series of kinetic energies generating a particular distribution of bond densities within the optically useful material. Based on the material's particular e-beam response, temperature distribution within the material, kinetic energy distribution of the electrons, and density of the material, a range of new material states can be generated. These new material states exhibit properties not available in the un-irradiated state. Preferred property changes include modification of the melting point (Tm) in waxes and oils and modification of optical clarity in waxes and oils. Exposure can be done through an aperture mask as known in the art or by embossing or forming an absorptive mask directly on the sample or on a thin carrier film support above the sample. In the case of films, dual sided processing can be used. The mask can be either sacrificial or permanent depending on the application. Once the sample is exposed, fabrication can commence.

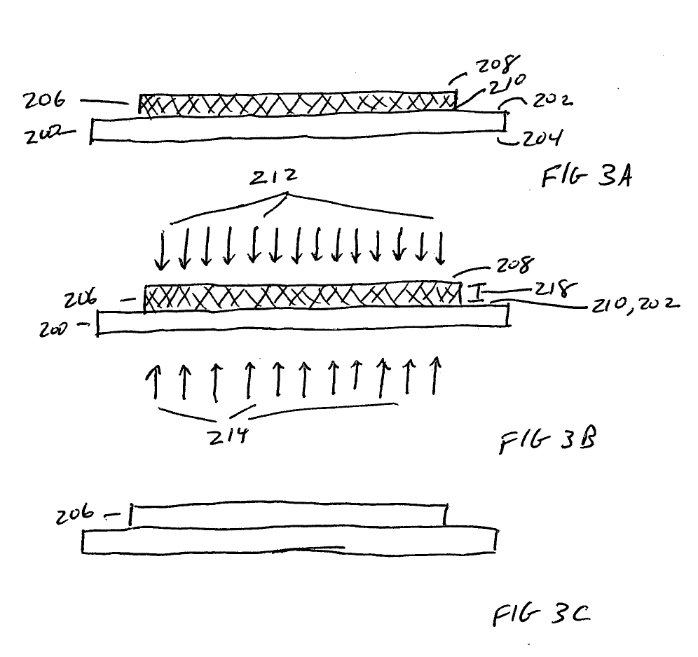

As shown in FIG. 3A, the substrate 200 has an upper surface 202 and a lower surface 204. The starting halogenated optical material layer 206 has an upper surface 208 and a lower surface 210. The lower surface 210 of the starting halogenated optical material layer is deposited, bonded, coated or otherwise positioned on the upper surface 202 of the substrate.

As shown in FIG. 3B, a large area electron beam 212 is incident at a perpendicular angle to the upper surface 208 of the optical material layer 206 and irradiates the optical material layer. Infrared radiation beams 214 will heat the substrate 200 and, by heat transfer through the substrate, will heat the starting halogenated optical material layer 206. The electron beam 212 fully penetrates the depth or thickness 218 of the halogenated optical material layer to the lower surface 210 of the optical material layer 206 and the upper surface 202 of the substrate 200.

As shown in FIG. 3C, the entire halogenated optical material layer 206, after electron beam irradiation and heating, will have its melt point temperature raised. The opaque optical material 206, after electron beam irradiation and heating, will also be more transparent to light, increasing its optical clarity. The starting halogenated optical material layer is crystalline. Incident light will scatter as it is transmitted through the layer causing the halogenated optical material layer to appear hazy. After electron beam irradiation and heating, the crystalline structure of the halogenated optical material layer has been randomized and made amorphous providing a clearer, more transparent halogenated optical material layer.

The halogenated optical material layer can be removed from the substrate by conventional chemical, etching or physical means. Alternately, a release layer can be deposited on the substrate and the starting halogenated optical material layer can be deposited on the release layer. The electron beam radiation and heat radiation will pass through the release layer without effecting the release layer or the transformation of the starting halogenated optical material layer. After the transformation process, the halogenated optical material layer can be lifted off the substrate by dissolving the release layer.

As a first illustrative example, a starting optical material of an opaque perfluorinated wax is melted onto a silicon substrate. The perfluorinated wax has a melt point of 43 degrees Celsius. The perfluorinated wax on the silicon substrate is exposed to a large area (200 millimeter diameter) electron beam operating at 28 keV at 0.25 ma and 100 μC/cm². Sufficient heat is supplied to melt the wax during electron beam irradiation.

After electron beam irradiation, the perfluorinated wax is optically clear. The perfluorinated wax was then heated to 100 degrees Celsius and did not melt or flow at this elevated temperature.

As a second illustrative example, a starting optical material of light scattering CTFE (Chlorotrifluoroethylene), such as Honeywell Aclar, is adhered to a silicon substrate. The CTFE has a melt point of 202 degrees Celsius. The CFTE on the silicon substrate is exposed to a large area (200 millimeter diameter) electron beam operating at 28 keV at 1.00 ma and 400 μC/cm². Infrared radiation raises the temperature of the CFTE above the melt point of 202 degrees Celsius.

After electron beam irradiation, the light scattering CFTE has less haze, has less light scattering and is more transparent to light.

A fluorinated oil can be combined with a fluorinated diacrylate monomer as a starting halogenated optical material mixture or compound. After e-beam irradiation, a newly created halogenated optical material results that is a clear solid film exhibiting a much higher CF content (i.e. lower optical loss at 1.55 μm). This results from the additional bonding caused by the e-beam irradiation allowing two normally non-reactive materials to form a new optically useful material. Because the oil in this particular case is fully fluorinated, its addition to the fluorinated diacrylate leads to a material with a higher CF to CH ratio, which exhibits less absorption at 1.55 μm.

As another example, UV opaque fillers of 5 nm FE203 particles were dispersed in fluorinated diacrylate monomer. After irradiation by e-beam, a non-scattering solid film was formed.

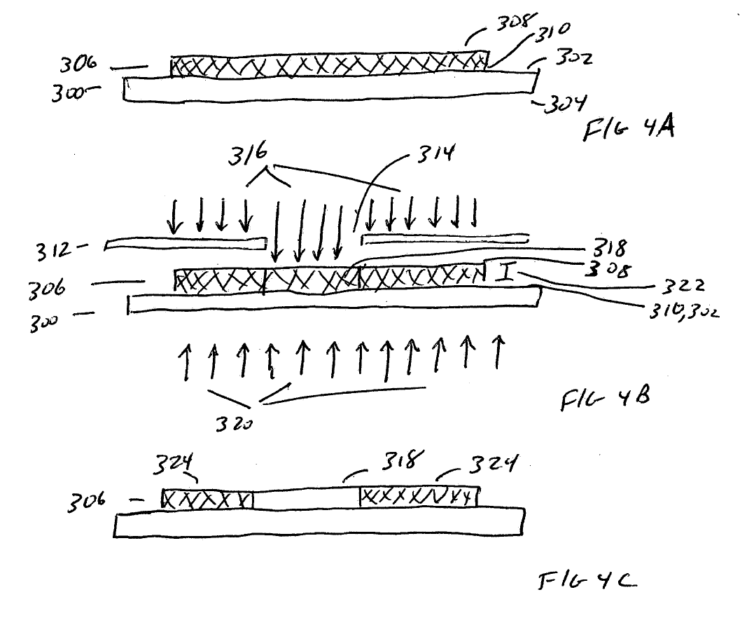

As shown in FIG. 4A, the substrate 300 has an upper surface 302 and a lower surface 304. The starting halogenated optical material layer 306 has an upper surface 308 and a lower surface 310. The lower surface 310 of the starting optical material layer is deposited, bonded, coated or otherwise positioned on the upper surface 302 of the substrate.

As shown in FIG. 4B, a mask 312 with an aperture 314 is placed between the electron beam source (not shown in this Figure) and the starting halogenated optical material layer 306 restricting the electron beam irradiation. The electron beam 316 will be blocked by the mask 312 but will be transmitted through the apertures 314 to irradiate the starting halogenated optical material 306 in a selected area 318.

The large area electron beam 316 is incident at a perpendicular angle to the upper surface 308 of the halogenated optical material layer 306 and irradiates the optical material layer through the aperture 314. Infrared radiation beams 320 will heat the substrate 300 and, by heat transfer through the substrate, will heat the selected area 318 of the starting halogenated optical material layer 306. The electron beam 316 fully penetrates the depth or thickness 322 at the area 318 of the halogenated optical material layer exposed through the mask aperture 314 to the lower surface 310 of the optical material layer 306 and the upper surface 302 of the substrate 300.

As shown in FIG. 4C, an area 318 of the halogenated optical material layer 306, after electron beam irradiation and heating, will have its melt point temperature raised and will be less opaque or more transparent to light, increasing its optical clarity. The surrounding area 324, where the electron beam 316 was blocked by the mask 312, was not irradiated and thus retains the lower melt point and the original relative opaqueness. The resulting halogenated optical material layer will have a transparent area within an opaque area.

The optical material layer can be removed from the substrate by conventional chemical, etching or physical means. Alternately, a release layer can be deposited on the substrate and the starting halogenated optical material layer can be deposited on the release layer. The electron beam radiation and heat radiation will pass through the release layer without effecting the release layer or the transformation of the starting halogenated optical material layer. After the transformation process, the halogenated optical material layer can be lifted off the substrate by dissolving the release layer.

The ability to selectively cross-link and harden waxes and oils via patterned electron beam irradiation lends itself to providing a means of fabricating three dimensional small parts or optical elements with the halogenated optical materials described herein.

While there has been described herein the principles of the invention, it is to be clearly understood to those skilled in the art that this description is made only by way of example and not as a limitation to the scope of the invention. Accordingly, it is intended, by the appended claims, to cover all modifications of the invention, which fall within the true spirit and scope of the invention.

What is claimed is:

1. An apparatus for increasing the melt point temperature of at least one starting halogenated optical material comprising:
a chamber for providing an exposure atmosphere,
a support member located within said chamber for supporting at least one starting halogenated optical material;
a source having a cathode and an anode for providing a large area electron beam within the chamber, said large area electron beam irradiating said at least one starting halogenated optical material, and
control means to control the large area electron beam to increase the melt point of said at least one starting halogenated optical material.

2. The apparatus for increasing the melt point temperature of at least one starting halogenated optical material of claim 1 further comprising:
heating means to raise the temperature of said at least one starting halogenated optical material during said large area electron beam irradiating said at least one starting halogenated optical material.

3. The apparatus for increasing the melt point temperature of at least one starting halogenated optical material of claim 2 wherein said heating means is located within said chamber.

4. The apparatus for increasing the melt point temperature of at least one starting halogenated optical material of claim 2 wherein said heating means can raise said temperature of said at least one starting halogenated optical material to between 10 degrees Celsius and 1000 degrees Celsius during said large area electron beam irradiating said at least one starting halogenated optical material.

5. The apparatus for increasing the melt point temperature of at least one starting halogenated optical material of claim 1 further comprising:
an aperture mask for limiting said large area electron beam irradiating said at least one starting halogenated optical material to a selected area on said at least one starting optical material.

6. The apparatus for increasing the melt point temperature of at least one starting halogenated optical material of claim 1 wherein the atmosphere in said chamber is between 1 milliTorr and 760 milliTorr.

7. The apparatus for increasing the melt point temperature of at least one starting halogenated optical material of claim 1 wherein said at least one starting halogenated optical material is a mixture of at least two different halogenated optical materials.

8. An apparatus for increasing the transparency of at least one starting halogenated optical material comprising:
a chamber for providing an exposure atmosphere,
a support member located within said chamber for supporting at least one starting halogenated optical material;
a source having a cathode and an anode for providing a large area electron beam within the chamber, said large area electron beam irradiating said at least one starting halogenated optical material, and
control means to control the large area electron beam to increase the transparency of said at least one starting halogenated optical material.

9. The apparatus for increasing the transparency of at least one starting halogenated optical material of claim 8 further comprising:
heating means to raise the temperature of said at least one starting halogenated optical material during said large area electron beam irradiating said at least one starting halogenated optical material.

10. The apparatus for increasing the transparency of at least one starting halogenated optical material of claim 9 wherein said heating means is located within said chamber.

11. The apparatus for increasing the transparency of at least one starting halogenated optical material of claim 9 wherein said heating means can raise said temperature of said at least one starting halogenated optical material to between 10 degrees Celsius and 1000 degrees Celsius during said large area electron beam irradiating said at least one starting halogenated optical material.

12. The apparatus for increasing the transparency of at least one starting halogenated optical material of claim 8 further comprising:
an aperture mask for limiting said large area electron beam irradiating said at least one starting halogenated optical material to a selected area on said at least one starting optical material.

13. The apparatus for increasing the transparency of at least one starting halogenated optical material of claim 8 wherein the atmosphere in said chamber is between 1 milliTorr and 760 milliTorr.

14. The apparatus for increasing the transparency of at least one starting halogenated optical material of claim 8 wherein said at least one starting halogenated optical material is a mixture of at least two different halogenated optical materials.

15. A method for increasing the melt point temperature of at least one starting halogenated optical material-comprising:
irradiating said at least one starting halogenated optical material with a large area electron beam source, and
controlling the energy of the electron beam source to increase the melt point of said at least one starting halogenated optical material.

16. The method for increasing the melt point temperature of at least one starting halogenated optical material of claim 15 further comprising the step of:
heating said at least one starting halogenated optical material during said irradiating said at least one starting halogenated optical material.

17. The method for increasing the melt point temperature of at least one starting halogenated optical material of claim 16 wherein said heating can raise said temperature of said at least one starting halogenated optical material to between 10 degrees Celsius and 1000 degrees Celsius during said irradiating said at least one starting halogenated optical material.

18. The method for increasing the melt point temperature of at least one starting halogenated optical material of claim 15 further comprising the step of:
masking said at least one starting halogenated optical material to limit said irradiating said at least one starting halogenated optical material to a selected area on said at least one starting halogenated optical material.

19. The method for increasing the melt point temperature of at least one starting halogenated optical material of claim 15 wherein the atmosphere during said irradiating said at least one starting halogenated optical material is between 1 milliTorr and 760 milliTorr.

20. The method for increasing the melt point temperature of at least one starting halogenated optical material of claim 15 further comprising the step of:
forming in said at least one starting halogenated optical material an increased melt point by creating additional bond structure in said at least one starting halogenated optical material.

21. The method for increasing the melt point temperature of at least one starting halogenated optical material of claim 15 wherein said at least one starting halogenated optical material is a mixture of at least two different halogenated optical materials.

22. A method for increasing the melt point temperature of at least one starting halogenated optical material-comprising:
irradiating said at least one starting halogenated optical material with a large area electron beam source, and
controlling the energy of the electron beam source to increase the melt point of said at least one starting halogenated optical material.

23. The method for increasing the melt point temperature of at least one starting halogenated optical material of claim 22 further comprising the step of:
heating said at least one starting halogenated optical material during said irradiating said at least one starting halogenated optical material.

24. The method for increasing the melt point temperature of at least one starting halogenated optical material of claim 23 wherein said heating can raise said temperature of said at least one starting halogenated optical material to between 10 degrees Celsius and 1000 degrees Celsius during said irradiating said at least one starting halogenated optical material.

25. The method for increasing the melt point temperature of at least one starting halogenated optical material of claim 22 further comprising the step of:
masking said at least one starting halogenated optical material to limit said irradiating said at least one starting halogenated optical material to a selected area on said at least one starting halogenated optical material.

26. The method for increasing the melt point temperature of at least one starting halogenated optical material of claim 22 wherein the atmosphere during said irradiating said at least one starting halogenated optical material is between 1 milliTorr and 760 milliTorr.

27. The method for increasing the melt point temperature of at least one starting halogenated optical material of claim 22 further comprising the step of:
forming in said at least one starting halogenated optical material an increased melt point by creating additional bond structure in said at least one starting halogenated optical material.

28. The method for increasing the melt point temperature of at least one starting halogenated optical material of claim 22 wherein said at least one starting halogenated optical material is a mixture of at least two different halogenated optical materials.
